(19) United States
(12) Patent Application Publication
(10) Pub. No.: US 2021/0257608 A1
(43) Pub. Date: Aug. 19, 2021

(54) NEGATIVE ELECTRODE OF LITHIUM-ION SECONDARY BATTERY AND MANUFACTURING METHOD THEREOF

(71) Applicant: TOYOTA JIDOSHA KABUSHIKI KAISHA, Toyota-shi (JP)

(72) Inventors: Hiroto ASANO, Nisshinn-shi (JP); Shinsuke MATSUHARA, Miyoshi-shi (JP)

(73) Assignee: TOYOTA JIDOSHA KABUSHIKI KAISHA, Toyota-shi (JP)

(21) Appl. No.: 17/120,406

(22) Filed: Dec. 14, 2020

(30) Foreign Application Priority Data
Feb. 17, 2020 (JP) 2020-024585

(51) Int. Cl. H01M 4/139; H01M 10/0525; H01M 4/62

(52) U.S. Cl. CPC H01M 4/139; H01M 2004/021; H01M 4/62; H01M 10/0525

(57) ABSTRACT

A manufacturing method of a negative electrode of a lithium-ion secondary battery, includes: preparing a negative electrode paste containing a negative electrode active material and a binder; and producing the negative electrode using the negative electrode paste. A ratio of a zeta potential of the binder to a zeta potential of the negative electrode active material is 3.5 or more and 9.0 or less.

### CROSS-REFERENCE TO RELATED APPLICATION

This application claims priority to Japanese Patent Application No. 2020-024585 filed on Feb. 17, 2020, incorporated herein by reference in its entirety.

### BACKGROUND

### 1. Technical Field

The present disclosure relates to a negative electrode of a lithium-ion secondary battery and a manufacturing method thereof.

### 2. Description of Related Art

A lithium-ion secondary battery is suitably used for a portable power source of a personal computer, a mobile terminal, or the like, and a power source for driving a vehicle such as an electric vehicle (EV), a hybrid vehicle (HV), and a plug-in hybrid vehicle (PHV).

A negative electrode used in the lithium-ion secondary battery typically has a configuration in which a negative electrode active material layer is provided on a negative electrode current collector. The negative electrode active material layer is generally produced by using a negative electrode paste containing a negative electrode active material and a binder (refer to, for example, Japanese Unexamined Patent Application Publication No. 2009-224099 (JP 2009-224099 A)). JP 2009-224099 A describes a technique for optimizing the amount of a water-soluble polymer of a thickener, which is to coat the surface of a negative electrode active material, by causing a negative electrode paste to have a zeta potential of −16.78 to −4.83 mV and a conductivity of 0.48 to 0.65 S·m⁻¹. JP 2009-224099 A describes that with this technique, the deposition of metallic lithium on a negative electrode due to the excess of the water-soluble polymer coating the surface of the negative electrode active material can be suppressed.

### SUMMARY

However, as the causes of the deposition of metallic lithium, there are causes other than those described in the related art, and therefore, in the related art, lithium deposition resistance is insufficient.

Therefore, the present disclosure provides a manufacturing method of a negative electrode of a lithium-ion secondary battery having excellent lithium deposition resistance.

A first aspect of the disclosure relates to a manufacturing method of a negative electrode of a lithium-ion secondary battery. The manufacturing method includes: preparing a negative electrode paste containing a negative electrode active material and a binder; and producing a negative electrode using the negative electrode paste. A ratio (ζ_{B}/ζ_{A}) of a zeta potential (ζ_{B}) of the binder to a zeta potential (ζ_{A}) of the negative electrode active material is 3.5 or more and 9.0 or less. According to the first aspect, the manufacturing method of the negative electrode of the lithium-ion secondary battery having excellent lithium deposition resistance is provided.

In the manufacturing method according to the first aspect, the zeta potential (ζ_{A}) of the negative electrode active material may be in a range from −3.1 mV to −5.5 mV. According to the first aspect, the lithium deposition resistance is further increased. In the manufacturing method according to the first aspect, the negative electrode paste may further include ceramic particles having a zeta potential of −25 mV or less in a pH range of 8 to 9. According to the first aspect, the lithium deposition resistance is further increased.

A second aspect of the disclosure relates to a negative electrode of a lithium-ion secondary battery. The negative electrode includes: a negative electrode active material; and a binder. An average diameter of the binder is 0.2 μm or more and 0.5 μm or less, and a peak half-width in a particle size distribution curve of the binder is 0.40 μm or more and 0.65 μm or less. According to the second aspect, the negative electrode of the lithium-ion secondary battery having excellent lithium deposition resistance is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view schematically illustrating an internal structure of a lithium-ion secondary battery using a negative electrode obtained by a manufacturing method according to an embodiment of the present disclosure;

FIG. 2 is a schematic exploded view illustrating a configuration of a wound electrode body of the lithium-ion secondary battery using the negative electrode obtained by the manufacturing method according to the embodiment of the present disclosure;

FIG. 3 is a reflected electron image showing a dispersed state of a binder of a negative electrode obtained in Example 1;

FIG. 4 is a reflected electron image showing a dispersed state of a binder of a negative electrode obtained in Comparative Example 1; and

FIG. 5 is a graph showing a charging and discharging pattern when a rated capacity in evaluation of lithium deposition resistance is measured.

### DETAILED DESCRIPTION OF EMBODIMENTS

Hereinafter, embodiments according to the present disclosure will be described with reference to the drawings. It should be noted that matters that are not mentioned in the present specification and are needed for carrying out the present disclosure can be understood as design matters for those skilled in the art based on the related art in the field. The present disclosure can be carried out based on the contents disclosed in the present specification and the common general technical knowledge in the art. In addition, in the following drawings, like members and portions that can obtain the same action are denoted by like reference numerals for description. The dimensional relationships (length, width, thickness, and the like) in each drawing do not reflect the actual dimensional relationships.

In the present specification, the term “secondary battery” refers to a power storage device that can be repeatedly charged and discharged, and is a term that includes a so-called storage battery and a power storage element such as an electric double layer capacitor.

In addition, in the present specification, the term “lithium-ion secondary battery” refers to a secondary battery in which lithium ions are used as charge carriers and charging and discharging are realized by movement of charges due to lithium ions between positive and negative electrodes.

A manufacturing method of a negative electrode of a lithium-ion secondary battery according to the present embodiment includes: a step of preparing a negative electrode paste containing a negative electrode active material and a binder (hereinafter, also referred to as “negative electrode paste preparation step”); and a step of producing a negative electrode using the negative electrode paste (hereinafter, also referred to as “negative electrode production step”). Here, the ratio (ζ_{B}/ζ_{A}) of the zeta potential (ζ_{B}) of the binder to the zeta potential (ζ_{A}) of the negative electrode active material is 3.5 or more and 9.0 or less.

In the present specification, the “paste” refers to a mixture in which a part or all of the solid content is dispersed in a solvent, and includes so-called “slurry”, “ink” and the like.

First, the negative electrode paste preparation step will be described. The negative electrode paste prepared in the step contains at least the negative electrode active material and the binder.

The kind of the negative electrode active material is not particularly limited as long as the above ratio (ζ_{B}/ζ_{A}) is 3.5 or more and 9.0 or less. As the negative electrode active material, carbon materials such as graphite, hard carbon, and soft carbon can be suitably used, and among these, graphite is preferable. The graphite may be natural graphite or artificial graphite. Alternatively, amorphous carbon-coated graphite in which the surface of graphite is coated with an amorphous carbon film may be used.

The zeta potential of the negative electrode active material is not particularly limited, but preferably in a range from −3.1 mV to −5.5 mV. When the zeta potential of the negative electrode active material is within this range, the agglomeration of the binder can be further suppressed, and the lithium deposition resistance of the negative electrode is further increased.

Here, the zeta potential of graphite is usually −2 mV or more. Therefore, in the present embodiment, graphite particles that have been subjected to a treatment of reducing the value of the zeta potential (that is, increasing the absolute value) are suitably used.

As a method of reducing the value of the zeta potential, a method of subjecting graphite to H₂O plasma treatment can be adopted. By subjecting graphite to the H₂O plasma treatment, the amount of surface hydroxyl groups increases, so that the value of the zeta potential can be reduced. Furthermore, the zeta potential can be easily adjusted by the plasma treatment conditions. The amount of surface hydroxyl groups on the graphite is not particularly limited, but is preferably 0.21 mmol/g or more and 0.30 mmol/g or less.

The zeta potential of the negative electrode active material can be obtained, for example, by performing a measurement by an electrophoretic light scattering method on a sample prepared by dispersing the negative electrode active material in ion-exchange water at a concentration of 0.05 g/L.

From this viewpoint, graphite having a zeta potential from −3.1 mV to −5.5 mV is proposed here. In particular, graphite having a zeta potential from −3.1 mV to −5.5 mV and a surface hydroxyl group amount of 0.21 mmol/g or more and 0.30 mmol/g or less is proposed here. The amount of surface hydroxyl groups can be obtained, for example, by neutralization titration.

In addition, a manufacturing method of the negative electrode active material containing the graphite subjected to the H₂O plasma treatment is proposed here. The H₂O plasma treatment can be performed by a known plasma treatment apparatus using H₂O as a kind of gas.

The average particle diameter of the negative electrode active material is not particularly limited, and is, for example, 50 μm or less, typically 1 μm or more and 20 μm or less, and preferably 5 μm or more and 15 μm or less.

In the present specification, the “average particle diameter” indicates the particle diameter (D50) at which the cumulative frequency is 50% in volume percentage in a particle size distribution measured by a laser diffraction/scattering method, unless otherwise specified.

The kind of the binder is not particularly limited as long as the ratio (ζ_{B}/ζ_{A}) is 3.5 or more and 9.0 or less. A rubber-based binder can be suitably used as the binder. Examples thereof include styrene butadiene rubber (SBR) and its modified product, acrylonitrile butadiene rubber and its modified product, acrylic rubber and its modified product, and fluororubber. Among these, SBR is preferable.

Here, the zeta potential of the binder is not particularly limited.

Rubber-based binders having various zeta potentials are known. The rubber-based binder is often copolymerized with a small amount of an acid monomer or an acrylic acid ester in order to enhance water dispersibility, and the zeta potential can be adjusted by the kind and amount of such a copolymerization component.

The zeta potential of the binder can be obtained, for example, by performing a measurement by the electrophoretic light scattering method on a sample prepared by dispersing the binder in ion-exchange water at a concentration of 0.05 g/L.

In the present embodiment, the ratio (ζ_{B}/ζ_{A}) of the zeta potential (ζ_{B}) of the binder to the zeta potential (ζ_{A}) of the negative electrode active material is 3.5 or more and 9.0 or less.

One of the causes of the deposition of metallic lithium on the negative electrode of the lithium-ion secondary battery is that the binder agglomerates in the negative electrode active material layer, and the agglomerated binder adheres to the negative electrode active material and becomes a resistor. Here, the zeta potential is a parameter associated with the surface potential of particles. Therefore, when the ratio (ζ_{B}/ζ_{A}) of the zeta potential (ζ_{B}) of the binder to the zeta potential (ζ_{A}) of the negative electrode active material is within the above range, the negative electrode active material and the binder in the negative electrode paste have an appropriate charged state, and the state of the negative electrode active material and the binder dispersed in the negative electrode paste is improved, thereby suppressing the agglomeration of the binder. As a result, the lithium deposition resistance of the negative electrode can be improved.

The negative electrode paste usually contains a solvent. An aqueous solvent is preferably used as the solvent. The aqueous solvent indicates water or a mixed solvent primarily containing water. As the solvent other than water contained in the mixed solvent, there is an organic solvent that can be uniformly mixed with water (for example, alcohols having four or less carbon atoms, and ketones having four or less carbon atoms). The aqueous solvent contains water in preferably 80 mass % or more, more preferably 90 mass % or more, and oven more preferably 95 mass % or more. Water is the most preferable as the solvent.

The negative electrode paste may contain components other than the above. Examples thereof include a thickener, ceramic particles, and a pH adjusting agent. Examples of the thickener include cellulose-based polymers such as carboxymethyl cellulose (CMC), methyl cellulose (MC), cellulose acetate phthalate (CAP), and hydroxypropyl methyl cellulose (HPMC), and polyvinyl alcohol (PVA). Among these, CMC is preferable.

It is preferable that the ceramic particles do not participate in charging and discharging reactions, and examples thereof include alumina, boehmite, and aluminum hydroxide. The ceramic particles are usually a material much harder than the negative electrode active material which is a carbon material, and thus can increase the mechanical strength of the negative electrode active material layer. Accordingly, deformation (expansion and compression) of the negative electrode active material layer when the lithium-ion secondary battery is charged and discharged can be suppressed, and cycle characteristics can be improved. Among the ceramic particles, ceramic particles exhibiting a zeta potential of −25 mV or less in a pH range of 8 to 9 are preferable. In a case where the negative electrode paste contains such ceramic particles, the lithium deposition resistance can be further improved. It is considered that this is because the filling state of the ceramic particles between the negative electrode active material and between the negative electrode and the binder is improved, and the followability to deformation (expansion and compression) of the negative electrode active material layer during charging and discharging of the lithium-ion secondary battery is enhanced.

The zeta potential of the ceramic particles can be obtained, by performing a measurement by the electrophoretic light scattering method on a sample prepared by dispersing the ceramic particles in ion-exchange water at a concentration of 0.05 g/L and adjusting the pH to a range of 8 to 9 with an aqueous solution of lithium hydroxide.

The average particle diameter of the ceramic particles is not particularly limited, but is, for example, 0.05 μm or more and 3 μm or less, and is preferably ⅕ or less of the average particle diameter of the negative electrode active material.

The proportion of the negative electrode active material in the total solid content of the negative electrode paste is preferably 50 mass % or more, more preferably 90 mass % or more and 99.5 mass % or less, and even more preferably 95 mass % or more and 99 mass % or less.

The proportion of the binder in the total solid content of the negative electrode paste is preferably 0.1 mass % or more and 8 mass % or less, more preferably 0.3 mass % or more and 5 mass % or less, and even more preferably 0.5 mass % or more and 2 mass % or less.

The proportion of the thickener in the total solid content of the negative electrode paste is preferably 0.3 mass % or more and 5 mass % or less, and more preferably 0.5 mass % or more and 2 mass % or less. The proportion of the ceramic particles in the total solid content of the negative electrode paste is preferably 0.5 mass % or more and 20 mass % or less, and more preferably 3 mass % or more and 15 mass % or less.

The solid content concentration of the negative electrode paste is, for example, 40 mass % or more, preferably 45 mass % or more and 80 mass % or less, and more preferably 50 mass % or more and 60 mass % or less. When the solid content concentration is within the above range, a drying efficiency of the negative electrode paste can be improved. In addition, handling of the negative electrode paste is facilitated, uniform coating is facilitated, and formation of a negative electrode active material layer having a uniform thickness is facilitated.

The negative electrode paste can be prepared by mixing the negative electrode active material, the binder, the solvent, and optional components according to a known method. As an example, first, the negative electrode active material and the thickener are dry-mixed, and a part of the solvent is added thereto to wet the mixture. After kneading the mixture as needed, the rest of the solvent is added to dilute the mixture. The binder is added thereto and stirred, thereby obtaining the negative electrode paste. As another example, the negative electrode active material and the thickener are dry-mixed, and the whole amount of the solvent is added, followed by kneading. The binder is added thereto and stirred, thereby obtaining the negative electrode paste. In a case where ceramic particles exhibiting a zeta potential of −25 mV or less in a pH range of 8 to 9 are used, it is preferable that the pH of the negative electrode paste is adjusted to, for example, 8 to 9 with a pH adjusting agent (for example, lithium hydroxide).

Next, the negative electrode production step will be described.

The production method of the negative electrode using the negative electrode paste is not particularly limited, but the negative electrode production step can be typically performed by performing: a step of applying the negative electrode paste to a negative electrode current collector (hereinafter, also referred to as “paste application step”), and; and a step of drying the applied negative electrode paste to form the negative electrode active material layer (hereinafter, also referred to as “drying step”).

In addition, after the drying step, a step of pressing the negative electrode active material layer (hereinafter, also referred to as “pressing step”) may also be performed.

The paste application step will be described.

As the negative electrode current collector, a conductive member made of a metal having good conductivity (for example, copper, nickel, titanium, or stainless steel) is typically used. The form of the negative electrode current collector is not particularly limited, but may be rod-shaped, plate-shaped, sheet-shaped, foil-shaped, mesh-shaped, or the like. The negative electrode current collector is preferably a copper foil.

In a case where the negative electrode current collector is a copper foil, the thickness thereof is not particularly limited, but is, for example, 6 μm or more and 30 μm or less.

The application of the negative electrode paste to the negative electrode current collector can be performed according to a known method. For example, the negative electrode paste can be applied onto the negative electrode current collector by using a coating device such as a gravure coater, a comma coater, a slit coater, or a die coater. The negative electrode active material layer may be formed on solely one surface of the negative electrode current collector, or may be formed on both surfaces, and is preferably formed on both surfaces. Therefore, the application of the negative electrode paste is performed on one surface or both surfaces of the negative electrode current collector, and is preferably performed on both surfaces.

Next, the drying step will be described. The drying step can be performed according to a known method. For example, the drying step can be performed by removing the solvent from the negative electrode current collector to which the negative electrode paste is applied, using a drying device such as a drying furnace. A drying temperature and a drying time may be appropriately determined according to the kind of the solvent used and are not particularly limited. The drying temperature is, for example, higher than 70° C. and 200° C. or lower (typically 110° C. or higher and 150° C. or lower). The drying time is, for example, 10 seconds or longer and 600 seconds or shorter (typically 30 seconds or longer and 300 seconds or shorter).

By performing the drying step, the negative electrode active material layer can be formed on the negative electrode current collector.

Next, the pressing step will be described. The pressing step can be performed according to a known method. For example, the pressing step can be performed by pressing the negative electrode active material layer formed as above by roll pressing or the like. By performing the pressing step, the thickness, coating amount, density, and the like of the negative electrode active material layer can be adjusted.

The negative electrode can be produced as described above.

The negative electrode produced in this manner has excellent lithium deposition resistance. This is because the agglomeration of the binder is suppressed as described above, and in the negative electrode produced as above, the binder is uniformly dispersed in the form of fine particles.

Specifically, since the agglomeration of the binder is suppressed, the average diameter of the binder is 0.2 μm or more and 0.5 μm or less, and a dispersed state in which the peak half-width of the binder in a particle size distribution curve is 0.40 μm or more and 0.65 μm or less can be achieved.

Therefore, from another aspect, as the negative electrode of the lithium-ion secondary battery having excellent lithium deposition resistance, a negative electrode of a lithium-ion secondary battery including a negative electrode active material and a binder, in which the average diameter of the binder is 0.2 μm or more and 0.5 μm or less, and the peak half-width of the binder in a particle size distribution curve is 0.40 μm or more and 0.65 μm or less is proposed here.

The average diameter and the particle size distribution curve of the binder can be obtained using, for example, a cross-sectional SEM image of the negative electrode active material layer. Specifically, for example, the average diameter and the particle size distribution curve of the binder can be obtained as follows. A sample of the negative electrode active material layer is prepared, and the binder is dyed with Os using OsO₄ as needed. The cross section of the negative electrode active material layer is observed with a scanning electron microscope (SEM) to obtain a reflected electron image. The reflected electron image is binarized with the binder and the others. The diameter of the binder clarified by the binarization process is measured. The diameter of the binder is calculated as the diameter of a circle having the same area as the image of the binder (so-called equivalent circle diameter), and the average value thereof is obtained as the average diameter. Commercially available software may be used for this measurement. In addition, based on the obtained data of the diameter of the binder, a particle size distribution curve having a frequency on the vertical axis and the diameter of the binder on the horizontal axis is created. From this curve, the peak width at half the height of a peak is obtained to obtain a peak half-width.

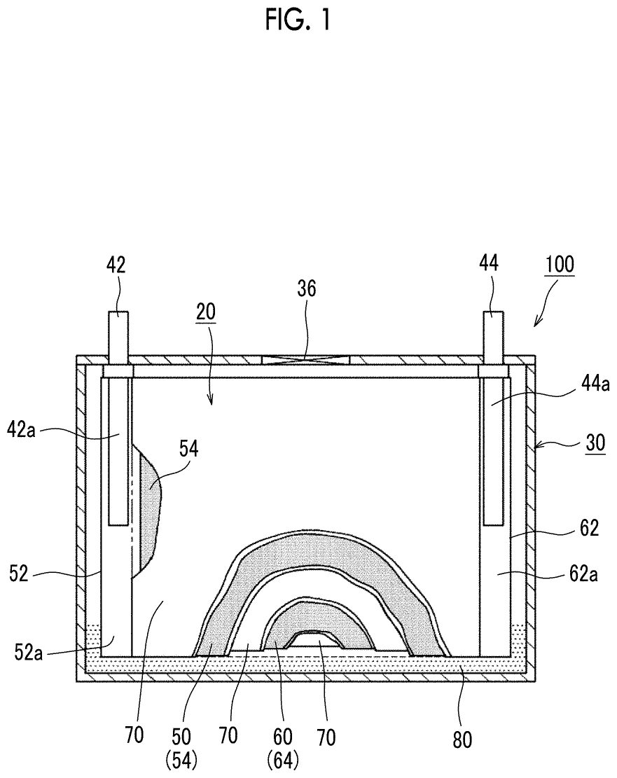

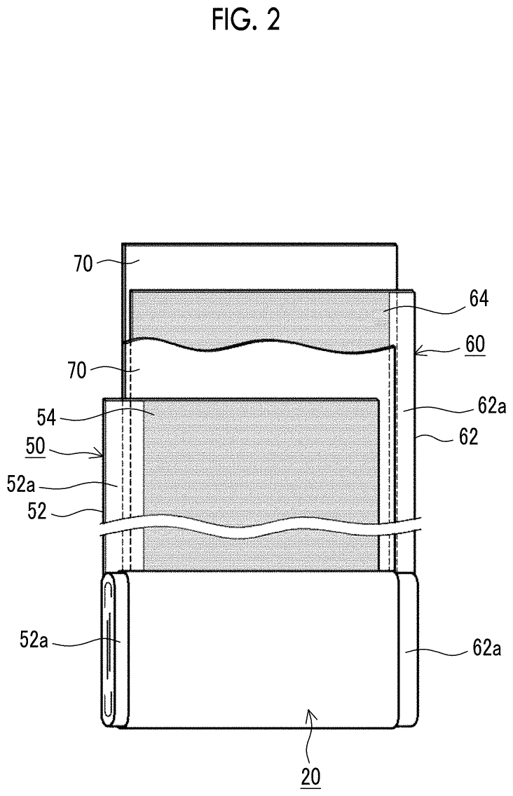

By using the negative electrode produced by the manufacturing method according to the present embodiment for a lithium-ion secondary battery, a lithium-ion secondary battery having excellent lithium deposition resistance can be provided. Therefore, a configuration example of a lithium-ion secondary battery produced using the negative electrode obtained by the manufacturing method according to the present embodiment will be described below with reference to FIGS. 1 and 2. The lithium-ion secondary battery configured by using the negative electrode obtained by the manufacturing method according to the present embodiment is not limited to the following example.

The lithium-ion secondary battery 100 illustrated in FIG. 1 is a sealed type battery constructed by accommodating a flat wound electrode body 20 and a non-aqueous electrolyte 80 in a flat rectangular battery case (that is, an exterior container) 30. The battery case 30 is provided with a positive electrode terminal 42 and a negative electrode terminal 44 for external connection, and a thin safety valve 36 set to release an internal pressure of the battery case 30 in a case where the internal pressure increases to a predetermined level or higher. Furthermore, the battery case 30 is provided with an injection port (not illustrated) through which the non-aqueous electrolyte 80 is injected. The positive electrode terminal 42 is electrically connected to a positive electrode current collector plate 42a. The negative electrode terminal 44 is electrically connected to the negative electrode current collector plate 44a. As a material of the battery case 30, for example, a metal material which is lightweight and has good thermal conductivity, such as aluminum, is used.

As illustrated in FIGS. 1 and 2, the wound electrode body 20 has a form in which a positive electrode sheet 50 and a negative electrode sheet 60 are overlapped with two long separator sheets 70 interposed therebetween and wound in a longitudinal direction. The positive electrode sheet 50 has a configuration in which a positive electrode active material layer 54 is formed on one surface or both surfaces (here, both surfaces) of a long positive electrode current collector 52 along the longitudinal direction. The negative electrode sheet 60 has a configuration in which a negative electrode active material layer 64 is formed on one surface or both surfaces (here, both surfaces) of a long negative electrode current collector 62 along the longitudinal direction. A positive electrode active material layer non-formed portion 52a (that is, a portion where the positive electrode active material layer 54 is not formed and the positive electrode current collector 52 is exposed) and a negative electrode active material layer non-formed portion 62a (that is, a portion where the negative electrode active material layer 64 is not formed and the negative electrode current collector 62 is exposed) are formed to extend outward from both ends of the wound electrode body 20 in a winding axis direction (that is, a sheet width direction orthogonal to the longitudinal direction). The positive electrode current collector plate 42a and the negative electrode current collector plate 44a are respectively joined to the positive electrode active material layer non-formed portion 52a and the negative electrode active material layer non-formed portion 62a.

Examples of the positive electrode current collector 52 forming the positive electrode sheet 50 include an aluminum foil. Examples of the positive electrode active material contained in the positive electrode active material layer 54 include lithium transition metal oxides (for example, LiN_{1/3}Co_{1/3}Mn_{1/3}O₂, LiNiO₂, LiCoO₂, LiFeO₂, LiMn₂O₄, and LiNi_{0.5}Mn_{1.5}O₄) and lithium transition metal phosphate compounds (for example, LiFePO₄). The positive electrode active material layer 54 may include components other than the active material, such as a conductive material and a binder. As the conductive material, for example, carbon black such as acetylene black (AB) and other carbon materials (for example, graphite) can be suitably used. As the binder, for example, polyvinylidene fluoride (PVdF) or the like can be used.

For the negative electrode sheet 60, the negative electrode obtained by the manufacturing method according to the present embodiment described above is used.

Examples of the separator 70 include a porous sheet (film) made of a resin such as polyethylene (PE), polypropylene (PP), polyester, cellulose, or polyamide. The porous sheet may have a single-layer structure or a laminated structure of two or more layers (for example, a three-layer structure in which a PP layer is laminated on both surfaces of a PE layer). A heat-resistant layer (HRL) may be provided on the surface of the separator 70.

As the non-aqueous electrolyte 80, the same as in a lithium-ion secondary battery of the related art can be used, and typically, an organic solvent (non-aqueous solvent) containing a supporting salt can be used. As the non-aqueous solvent, organic solvents such as various carbonates, ethers, esters, nitriles, sulfones, and lactones used in the electrolytic solution of a general lithium-ion secondary battery can be used without particular limitation. Among these, carbonates are preferable, and examples thereof include ethylene carbonate (EC), propylene carbonate (PC), diethyl carbonate (DEC), dimethyl carbonate (DMC), ethylmethyl carbonate (EMC), monofluoroethylene carbonate (MFEC), difluoroethylene carbonate (DI-BC), monofluoromethyldifluoromethyl carbonate (F-DMC), and trifluorodimethyl carbonate (TFDMC). Such non-aqueous solvents can be used singly or in an appropriate combination of two or more. As the supporting salt, for example, lithium salts (preferably LiPF₆) such as LiPF₆, LiBF₄, and LiClO₄ can be suitably used. The concentration of the supporting salt is preferably 0.7 mol/L or more and 1.3 mol/L or less.

In addition, for example, various additives such as a gas generating agent such as biphenyl (BP) or cyclohexylbenzene (CHB); a film forming agent such as an oxalato complex compound containing at least one of a boron atom and a phosphorus atom, or vinylene carbonate (VC); a dispersant; and a thickener may be included to the non-aqueous electrolytic solution.

The lithium-ion secondary battery 100 configured as described above can be used for various purposes. Suitable applications include a driving power source mounted in a vehicle such as an electric vehicle (EV), a hybrid vehicle (HV), and a plug-in hybrid vehicle (PHV). The lithium-ion secondary battery 100 can also be used in the form of a battery pack, which is typically a plurality of batteries connected at least in series or in parallel.

As an example, the rectangular lithium-ion secondary battery including the flat wound electrode body has been described. However, the configuration of the lithium-ion secondary battery including the negative electrode obtained by the manufacturing method according to the present embodiment is not limited thereto. The lithium-ion secondary battery can also be configured as a lithium-ion secondary battery including a laminated electrode body, such as a coin-type lithium-ion secondary battery, a cylindrical lithium-ion secondary battery, and a laminated lithium-ion secondary battery.

Hereinafter, examples according to the present disclosure will be described, but the present disclosure is not intended to be limited to the examples described below.

### Examples 1 to 4 and Comparative Examples 1 to 5

Preparation of Negative Electrode Active Material and Binder

Graphite having a zeta potential of −1.2 mV was prepared. The average particle diameter (D50) of the graphite was 8 μm. Into a chamber type plasma generating device, 200 g of the graphite was put. The kind of gas was set to H₂O, the internal pressure of a chamber was set to 20 Pa, and a plasma treatment was performed for 90 minutes to obtain graphite having a zeta potential of −3.1 mV. Furthermore, by lengthening the H₂O plasma treatment time, graphite having a zeta potential of −5.5 mV and graphite having a zeta potential of −8.8 mV were obtained. Five kinds of commercially available SBR were prepared. The zeta potentials thereof were respectively −5 mV, −11 mV, −17 mV, −28 mV, and −33 mV. The zeta potentials of the graphite and a binder were measured as follows. A sample was produced by dispersing the graphite or the binder in ion-exchange water at a concentration of 0.05 g/L. The zeta potential of the sample was measured using a zeta potential measurement system “ELSZ-2000Z” (manufactured by OTSUKA ELECTRONICS Co., LTD). The amount of surface hydroxyl groups of each graphite was obtained by neutralization titration. The results are shown in Table 1.

Production of Negative Electrode

Graphite having the zeta potential shown in Table 1 and carboxymethyl cellulose (CMC) as a thickener were dry-mixed, and thereafter water was added thereto. After kneading the mixture, styrene-butadiene rubber (SBR) having the zeta potential shown in Table 1 was added and stirred to prepare a negative electrode paste. The ratio between the components of the solid content was set to graphite:SBR:CMC=98:1:1 (mass ratio). The obtained negative electrode paste was applied in a strip shape onto both surfaces of a long copper foil having a thickness of 10 μm, dried, and roll-pressed to produce a negative electrode sheet.

Evaluation of Dispersed State of Binder

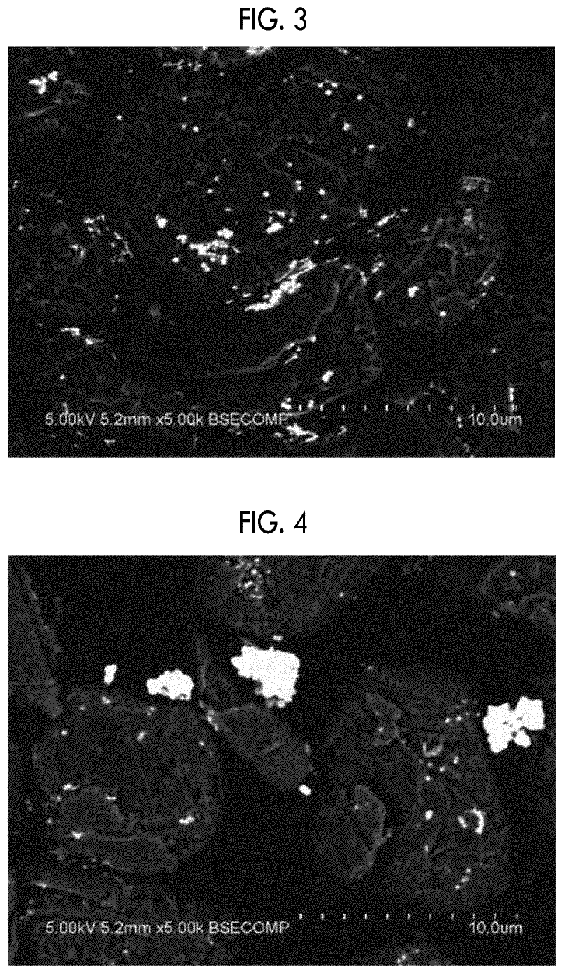

The obtained negative electrode sheet was cut, and in the cross section, the binder was dyed with Os using OsO₄. The cross section of a negative electrode active material layer was observed with a scanning electron microscope (SEM) to obtain a reflected electron image. The reflected electron image was binarized with the binder and the others. The diameter of the binder clarified by the binarization process was measured. The diameter of the binder was calculated as the diameter of a circle having the same area as the image of the binder (so-called equivalent circle diameter), and the average value thereof was obtained as the average diameter. Commercially available software (Jimage-fiji) was used for this measurement. Based on the obtained data of the diameter of the binder, a particle size distribution curve having a frequency on the vertical axis and the diameter of the binder on the horizontal axis was created. From this curve, the peak width at half the height of a peak was obtained to obtain a peak half-width. The results are shown in Table 1. As a reference, reflected electron images of the negative electrodes of Example 1 and Comparative Example 1 are shown in FIGS. 3 and 4.

Production of Lithium-Ion Secondary Battery for Evaluation

LiN_{1/3}Co_{1/3}Mn_{1/3}O₂ (LNCM) as a positive electrode active material, acetylene black (AB) as a conductive material, and polyvinylidene fluoride (PVdF) as a binder were mixed in a mass ratio of LNCM:AB:PVdF=92:5:3 with N-methylpyrrolidone (NMP) to prepare a slurry for forming a positive electrode active material layer. This slurry was applied on both surfaces of a long aluminum foil having a thickness of 15 μm in a width of 100 mm, dried, and then roll-pressed to a predetermined thickness, thereby producing a positive electrode sheet.

A separator sheet was prepared in which a ceramic layer (heat-resistant layer) having a thickness of 4 μm was formed on the surface of a porous polyolefin sheet having a three-layer structure of PP/PE/PP and having a thickness of 24 μm. The positive electrode sheet and the negative electrode sheet produced above were caused to face each other with the separator sheet therebetween, thereby producing an electrode body. The heat-resistant layer of the separator sheet was caused to face the negative electrode.

In a mixed solvent containing ethylene carbonate (EC), dimethyl carbonate (DMC), and ethyl methyl carbonate (EMC) in a volume ratio of EC:DMC:EMC=3:3:4, LiPF₆ was dissolved in a concentration of 1.0 mol/L, thereby preparing a non-aqueous electrolytic solution.

An aluminum case provided with a lid having a liquid injection port and a case body was prepared.

Electrode terminals and current collector plates were attached to the lid. Then, the produced electrode body and the current collector plates were joined by welding.

The electrode body thus joined to the lid body was inserted into the case body, and the lid and the case body were welded.

A predetermined amount of the prepared non-aqueous electrolytic solution was injected through the liquid injection port, and a sealing screw was tightened at the liquid injection port for sealing.

The electrode body was left for a predetermined time so as to be impregnated with the non-aqueous electrolytic solution, thereby obtaining a lithium-ion secondary battery for evaluation.

Next, each lithium-ion secondary battery for evaluation was subjected to initial charging. Specifically, the above-produced lithium-ion secondary battery was subjected to constant current charging to 4.1 V at a current value of ⅓C, and thereafter subjected to constant voltage charging until the current value became 1/50C to be fully charged.

Next, an aging treatment was performed thereon for 20 hours in a thermostat at 50° C.

Evaluation of Lithium Deposition Resistance

The lithium-ion secondary batteries for evaluation of each example and each comparative example were adjusted to SOC 56% and placed in a temperature environment of −10° C.

Charging and discharging, in which constant current charging at 20 C for 30 seconds, suspension for 10 minutes, constant current discharging at 20 C for 30 seconds, and suspension for 10 minutes were set as one cycle, were repeated 1000 cycles.

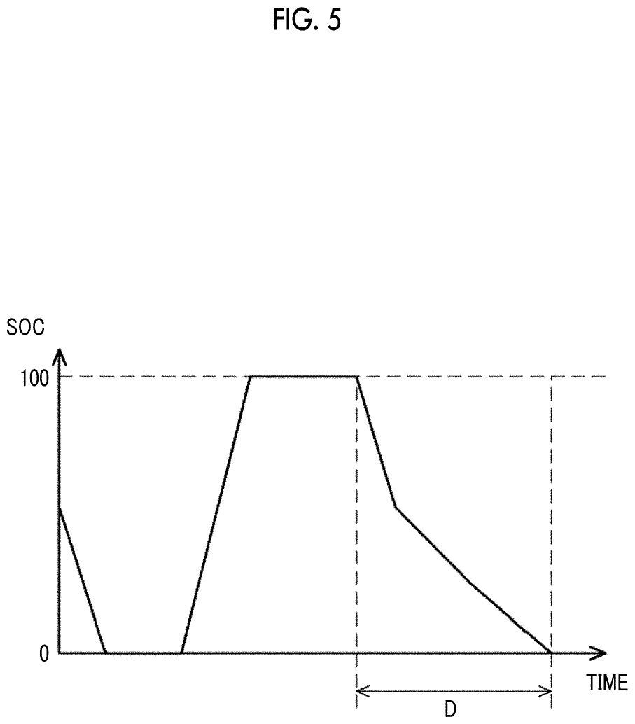

Before and after the 1000 cycles of the charging and discharging, charging and discharging (energizing current: 0.5 C) in a pattern shown in FIG. 5 were performed, and the discharging capacity during the period indicated by arrow D was measured as a rated capacity. The capacity retention ratio (%) was calculated from (rated capacity after cycle charging and discharging/rated capacity before cycle charging and discharging)×100. The results are shown in Table 1.

TABLE 1

| | Negative electrode active | | | | | | Li deposition |
|---|---|---|---|---|---|---|---|
| | material | | | | | | resistance |
| | | Amount of | Binder | | Binder distribution | | Capacity |
| | Zeta | hydroxyl | Zeta | | Average | | retention |
| | potential A | groups | potential B | Ratio | diameter | Half-width | ratio |
| | (mV) | (mmol/g) | (mV) | B/A | (μm) | (μm) | (%) |
| Comparative | −1.2 | 0.12 | −11 | 9.2 | 1.3 | 1.82 | 88 |
| Example 1 | | | | | | | |
| Comparative | −1.2 | 0.12 | −17 | 14.2 | 1.4 | 1.61 | 86 |
| Example 2 | | | | | | | |
| Comparative | −3.1 | 0.21 | −5 | 1.6 | 1.6 | 1.55 | 84 |
| Example 3 | | | | | | | |
| Example 1 | −3.1 | 0.21 | −11 | 3.5 | 0.5 | 0.49 | 92 |
| Example 2 | −3.1 | 0.21 | −17 | 5.5 | 0.2 | 0.40 | 93 |
| Example 3 | −3.1 | 0.21 | −28 | 9.0 | 0.3 | 0.44 | 91 |
| Comparative | −3.1 | 0.21 | −33 | 10.6 | 0.3 | 0.38 | 88 |
| Example 4 | | | | | | | |
| Example 4 | −5.5 | 0.30 | −28 | 5.1 | 0.5 | 0.65 | 92 |
| Comparative | −8.8 | 0.38 | −28 | 3.2 | 0.6 | 0.77 | 87 |
| Example 5 | | | | | | | |

As shown by the results of Table 1, in Examples 1 to 4 within the range of the manufacturing method according to the present embodiment, the capacity retention ratio was high. Since a decrease in capacity is caused by the deposition of metallic lithium, a higher capacity retention ratio means higher lithium deposition resistance. Therefore, according to the manufacturing method disclosed here, it can be seen that a negative electrode of a lithium-ion secondary battery having excellent lithium deposition resistance can be manufactured.

### Examples 5 to 8

Graphite having a zeta potential of −3.1 mV, carboxymethyl cellulose (CMC) as a thickener, and ceramic particles (CP) shown in Table 2 were dry-mixed, and water and an aqueous solution of lithium hydroxide were added to the mixture to reach a pH of 9. After kneading the mixture, SBR having a zeta potential of −17 mV was added and stirred to prepare a negative electrode paste. The ratio between the components of the solid content was set to C:SBR:CMC:CP=88:1:1:10 (mass ratio).

The zeta potential of the ceramic particles was measured as follows. A sample was prepared by producing a dispersion liquid in which ceramic particles were dispersed in ion-exchange water at a concentration of 0.05 g/L, and adjusting the pH to a range of 8 to 9 using an aqueous solution of lithium hydroxide. The zeta potential of the sample was measured using a zeta potential measurement system “ELSZ-2000Z” (manufactured by OTSUKA ELECTRONICS Co., LTD).

The obtained negative electrode paste was applied in a strip shape onto both surfaces of a long copper foil having a thickness of 10 μm, dried, and roll-pressed to produce a negative electrode sheet.

Using the produced negative electrode sheet, a lithium-ion secondary battery for evaluation was produced in the same manner as above, and evaluation of lithium deposition resistance (measurement of capacity retention rate) was performed.

The results are shown in Table 2.

TABLE 2

| | | | | | | Li deposition |
|---|---|---|---|---|---|---|
| | Negative electrode | | | | | resistance |
| | active material | Binder | | Ceramic particles | | Capacity |
| | Zeta | Zeta | | | Zeta | retention |
| | potential A | potential B | | | potential C | ratio |
| | (mV) | (mV) | Ratio B/A | Kind | (mV) | (%) |
| Example 5 | −3.1 | −17 | 5.5 | Alumina | −19 | 93 |
| Example 6 | −3.1 | −17 | 5.5 | Alumina | −32 | 94 |
| Example 7 | −3.1 | −17 | 5.5 | Alumina | −40 | 95 |
| Example 8 | −3.1 | −17 | 5.5 | Boehmite | −25 | 94 |

From the results in Table 2, it can be seen that the lithium deposition resistance can be further improved by the use of the ceramic particles having a zeta potential of −25 mV or less in a pH range of 8 to 9.

While specific examples of the present disclosure have been described above in detail, these are merely examples and do not limit the scope of the claims. The technology described in the claims includes various modifications and changes of the specific examples illustrated above.

What is claimed is:

1. A manufacturing method of a negative electrode of a lithium-ion secondary battery, the manufacturing method comprising:
preparing a negative electrode paste containing a negative electrode active material and a binder; and
producing the negative electrode using the negative electrode paste,
wherein a ratio of a zeta potential of the binder to a zeta potential of the negative electrode active material is 3.5 or more and 9.0 or less.

2. The manufacturing method according to claim 1, wherein the zeta potential of the negative electrode active material is in a range from −3.1 mV to −5.5 mV.

3. The manufacturing method according to claim 1, wherein the negative electrode paste further contains ceramic particles having a zeta potential of −25 mV or less in a pH range of 8 to 9.

4. A negative electrode of a lithium-ion secondary battery, the negative electrode comprising:
a negative electrode active material; and
a binder, wherein:
an average diameter of the binder is 0.2 μm or more and 0.5 μm or less; and
a peak half-width in a particle size distribution curve of the binder is 0.40 μm or more and 0.65 μm or less.
